(19) United States
(12) Patent Application Publication
(10) Pub. No.: US 2026/0269721 A1
(43) Pub. Date: Sep. 10, 2026

(54) QUIET CHARGE PUMP

(71) Applicant: Qorvo US, Inc., Greensboro, NC (US)

(72) Inventor: Stephen James Franck, Felton, CA (US)

(21) Appl. No.: 19/121,108

(22) PCT Filed: Oct. 30, 2023
(86) PCT No.: PCT/US2023/036233

§ 371 Date: Apr. 14, 2025

Related U.S. Application Data
(60) Provisional application No. 63/384,001, filed on Nov. 16, 2022.
(60) Provisional application No. 63/523,016, filed on Jun. 23, 2023.

(51) Int. Cl. H02M 3/07; H02M 1/14; H02M 1/44; H04B 1/18

(52) U.S. Cl. CPC H02M 3/07; H02M 1/143; H02M 1/44; H04B 1/18

(57) ABSTRACT

A quiet charge pump comprises a charge pump with a floating current source and a pre-filter. The floating current source comprises a transistor. The pre-filter comprises a capacitor and a resistor. In one aspect, the capacitor and resistor in the pre-filter serve as a low-pass filter on a gate-to-source voltage (VGS) and the current flowing to the charge pump input. At low clock frequencies, the pre-filter causes the floating current source to respond advantageously slowly to average demand of the charge pump. This slower response input to the charge pump reduces the noise created by the charge pump. At higher clock frequencies, the pre-filter is disengaged to allow the floating current source to provide more responsive input to the charge pump. A switch is provided to disengage the pre-filter to enable the charge pump to operate quietly, normally, at higher clock frequencies using a Pi filter.

### RELATED APPLICATIONS

This application claims the benefit of provisional patent application Ser. No. 63/523,016, filed Jun. 23, 2023, and claims the benefit of provisional patent application Ser. No. 63/384,001, filed Nov. 16, 2022, the disclosures of which are hereby incorporated herein by reference in their entireties.

### FIELD OF THE DISCLOSURE

Embodiments of the present disclosure relate to charge pumps having reduced electrical noise emission.

### BACKGROUND

A charge pump transfers charge on each clock edge to generate a direct current voltage or current from an input voltage supply to an output voltage. A capacitor charged to an input supply is disconnected fully charged from the positive input supply and connected across the negative output supply and then returned to the input voltage supply to create the charge pump.

However, a spectrum of switching current noise at the clock frequency and at odd harmonics of the clock frequency also results, which is not desirable. Filtering using what is known as a Pi filter can attenuate this noise in the high-frequency spectrum. Unfortunately, due to the configuration of their capacitors, Pi filters are mostly ineffective at lower frequency, particularly at reduced clock frequency. Reduced clock frequencies are common in devices when trying to save switching power under low load conditions. Accordingly, it would be desirable to provide a quiet charge pump that provides a quiet load current across a broad spectrum of clock frequencies.

### SUMMARY

According to an aspect of the present disclosure, a quiet charge pump comprises a charge pump with a floating current source and a pre-filter. The floating current source comprises a transistor, a metal-oxide semiconductor transistor. The pre-filter comprises a capacitor and a resistor. In one aspect, the capacitor and resistor in the pre-filter serve as a low-pass filter on a gate-to-source voltage (VGS) and a current flowing to the charge pump input. The capacitor is coupled to the transistor from gate to source. A diode-connected resistor at direct current (DC) is also coupled from gate to drain. At low clock frequencies, the pre-filter causes the VGS and current of the transistor in the floating current source to respond advantageously slowly to average demand of the charge pump. This slower response input to the charge pump reduces the noise created by the charge pump. At higher clock frequencies, the pre-filter is disengaged (e.g., shorted) to allow the transistor in the floating current source to provide more responsive input to the charge pump. In an aspect, a switch across the drain-to-source voltage of the transistor is provided to disengage or short the pre-filter and thus to enable the charge pump to operate quietly, normally, at higher clock frequencies, where a capacitor-resistor-capacitor circuit, a Pi filter, is effective. Disengaging the pre-filter at high clock frequencies where the Pi filter is effective allows for faster charging of the charge pump in its operational modes. Accordingly, the quiet charge pump performs more quietly, with less noise, across low and high clock frequencies.

In one aspect, a charge pump is configured to generate an output voltage based on a variable frequency clock signal. A Pi filter is coupled to the charge pump and is configured to filter the output of the charge pump above a first frequency of the variable clock signal. A current source is coupled to the charge pump and is configured to provide a current to the charge pump, wherein the current source comprises a transistor having a gate, a source, and a drain, and wherein the current source is configured to provide a current responsive to a demand of the charge pump based on a VGS applied during each clock cycle of the clock signal. A pre-filter is coupled to the current source and configured to maintain the VGS at a desired level based when the variable frequency clock signal is below a first frequency. The pre-filter comprises a capacitor coupled to the transistor from the gate to the source and a resistor coupled between the capacitor and the transistor from the gate to the drain.

In regard to another aspect, a method of operating a charge pump is disclosed. An input voltage and a clock signal having a variable clock frequency are received. A gate-to-source voltage (VGS) applied to a transistor and maintained via a capacitor coupled to the transistor from gate to source. The VGS applied to the transistor is maintained to be equivalent to a drain voltage of the transistor based on an average value of a drain-to-source voltage (VDS). An output is provided from the transistor based on the input voltage and the clock signal based on the VGS and the current applied.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawings.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A illustrates an exemplary circuit for a quiet charge pump according to an aspect of the present disclosure.

FIG. 1B illustrates an exemplary controller for the quiet charge pump and how it interfaces with the exemplary circuit of the quiet charge pump shown in FIG. 1A according to the present disclosure.

FIGS. 2A and 2B illustrate the performance of an embodiment according to the present disclosure, as shown by the solid line.

FIG. 3 illustrates the performance of an embodiment according to the present disclosure.

FIG. 4 illustrates the performance of an embodiment according to the present disclosure.

FIG. 5 illustrates exemplary current spikes of a conventional charge pump that are resolved according an aspect of the present disclosure.

FIG. 6 illustrates the effects on current spikes of an aspect of an exemplary quiet charge pump and its performance according to the present disclosure.

FIG. 7 illustrates an exemplary process flow for operating the charge pump of FIGS. 1A and 1B according to the present disclosure.

FIG. 8 illustrates an exemplary user element that may utilize the quiet charge pump shown in FIGS. 1A and 1B.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

According to an aspect of the present disclosure, a quiet charge pump comprises a charge pump with a floating current source and a pre-filter. The floating current source comprises a transistor, a metal-oxide semiconductor transistor. The pre-filter comprises a capacitor and a resistor. In one aspect, the capacitor and resistor in the pre-filter serve as a low-pass filter on a gate-to-source voltage (VGS) and a current flowing to the charge pump input. The capacitor is coupled to the transistor from gate to source. A diode-connected resistor at DC is also coupled from gate to drain. At low clock frequencies, the pre-filter causes the VGS and the current of the transistor in the floating current source to respond advantageously slowly to average demand of the charge pump. This slower response input to the charge pump reduces the noise created by the charge pump. At higher clock frequencies, the pre-filter is disengaged (e.g., shorted) to allow the transistor in the floating current source to provide more responsive input to the charge pump. In an aspect, a switch across the drain-to-source voltage of the transistor is provided to disengage or short the pre-filter and thus to enable the charge pump to operate quietly, normally, at higher clock frequencies, frequencies where a Pi filter is effective. Disengaging the pre-filter at high clock frequencies where the Pi filter is effective allows for fastest charging of the charge pump in its operational modes. Accordingly, the quiet charge pump performs more quietly, with less noise across a spectrum of both low and high clock frequencies.

As noted, charge pumps typically use capacitor-resistor-capacitor or Pi filters to reduce noise generated by the charge pump at the clock edges of its clock signal. However, Pi filters are not effective at lower frequencies.

Therefore, for devices having variable clock speeds that use lower clock frequencies in low load conditions, charge pumps with merely a Pi filter are insufficient.

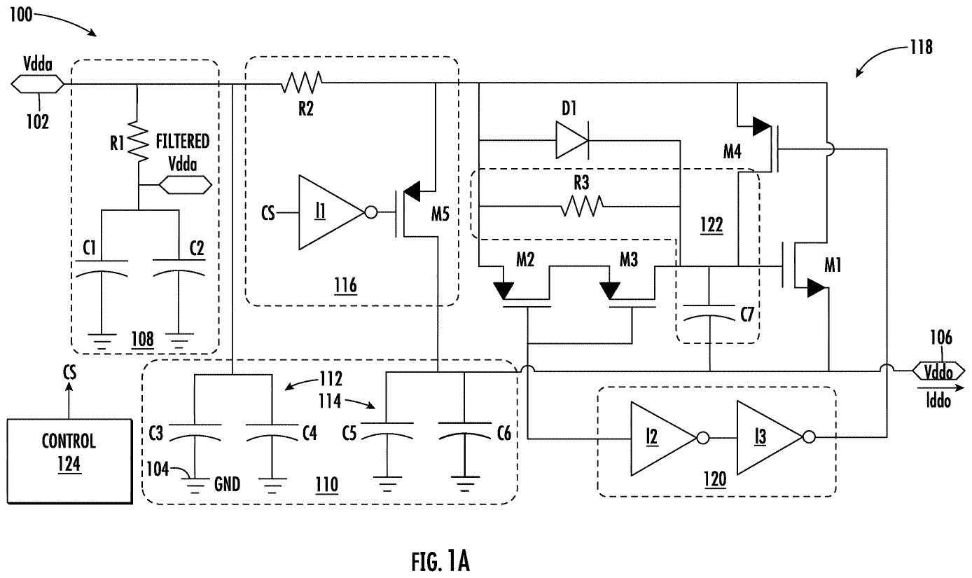

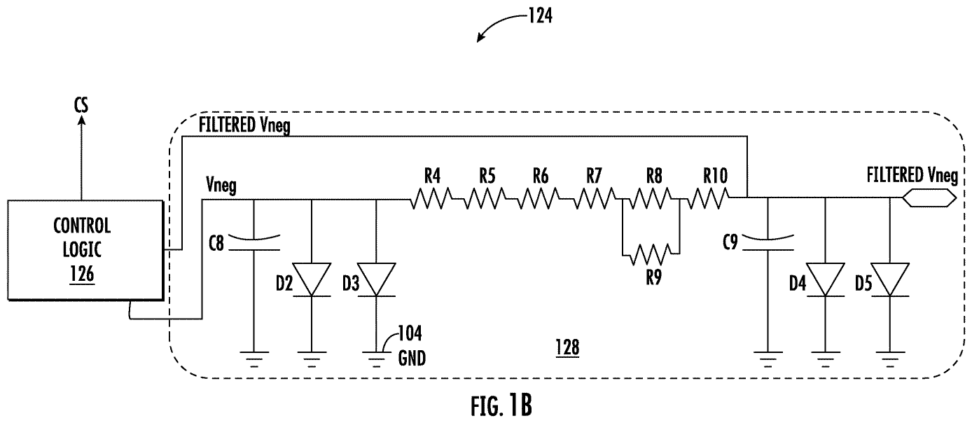

In this regard, FIGS. 1A and 1B illustrate a circuit diagram for a quiet charge pump 100 according to an aspect of the present disclosure to enable quieter operation with regard to spectral noise across low and high clock frequencies. As shown, in one aspect, the quiet charge pump 100 comprises a supply voltage rail 102, a ground rail 104, an output 106, a supply voltage filter 108, a capacitor ladder circuit 110 having, for example, a first stage 112 and a second stage 114, a switch 116, a floating current source 118, a level shifter 120, a pre-filter 122, and a controller 124. The quiet charge pump 100 can be used in a variety of applications, such as in battery-powered devices or voltage multipliers. The quiet charge pump 100 can be designed in a variety of configurations, such as voltage inverters or voltage multipliers. In one aspect, the quiet charge pump 100 may be a DC-DC voltage converter that is configured to generate a higher or lower DC voltage from an input voltage.

The quiet charge pump 100 receives an input voltage from the supply voltage rail 102 supplying an input voltage Vdda. The ground rail 104 supplies a ground reference GND. The output terminal 106 provides an output voltage Vddo with an output current Iddo. The quiet charge pump 100 operates by charging and discharging capacitors using the controller 124 (as will be further described with reference to FIG. 1B) to control one or more elements within its circuitry.

Referring to FIG. 1A, unlike a conventional charge pump, the quiet charge pump 100 utilizes the floating current source 118 and the pre-filter 122 to enable quiet operations with regard to undesirable spectral emission at low (such as below 1.5 MHz) and high (such as above 1.5 MHz) clock frequencies. The floating current source 118 comprises a transistor M1. The transistor M1 may be a P-type metal-oxide semiconductor transistor (PMOS), or an N-type metal-oxide semiconductor (NMOS) transistor. Of note, in conventional charge pumps, a transistor is typically diode-connected, gate-to-drain shorted to drop a voltage (such as 0.7 volts). In one aspect, the transistor M1 is instead configured as a floating or constant current source. In addition, the pre-filter 122 is coupled to the transistor M1 in the floating current source 118 to enable equalizing the quiet charge pump 100 current demand, for example, from the supply voltage rail 102.

Accordingly, in one aspect in the pre-filter 122 is a low-pass filter that is configured to filter undesirable high frequency components from the current flowing to the input into the quiet charge pump 100. The filtering causes the gate-to-source voltage (i.e., VGS) of transistor M1 and current to respond advantageously slowly to the average demand of the quiet charge pump 100, as indicated by the drain-to-source voltage (VDS). This slower response input by the floating current source 118 reduces the noise created by the quiet charge pump 100, for example, at low clock frequencies (such as below 1.5 MHz). The other various supporting elements and a description of their operation in the quiet charge pump 100 will now be further described to explain the features and benefits of the floating current source 118 and the pre-filter 122 in the quiet charge pump 100.

For purposes of illustration, FIG. 1A also shows other components of the quiet charge pump 100. The components and exemplary operation functions will now be further described.

The supply voltage rail 102 supplies input voltage Vdda from a power supply (not shown for sake of brevity) that provides power to the quiet charge pump 100. The supply voltage rail 102 may provide a positive or negative input voltage Vdda with respect to the common ground, i.e., the ground rail 104. Alternatively, the supply voltage rail 102 may provide a DC voltage that is referenced to another voltage level.

The ground rail 104 provides a reference GND and serves as a common return path for current for the quiet charge pump 100. The ground rail 104 can be implemented in a variety of ways, depending on the specific circuit design and application. For example, the ground rail 104 may be a conductive plane on a printed circuit board, signal grounds, or chassis grounds to provide a grounding path and reduce noise in the quiet charge pump 100. Alternatively, the quiet charge pump 100 may utilize a negative voltage rail rather than a ground rail depending on the desired application for the quiet charge pump 100.

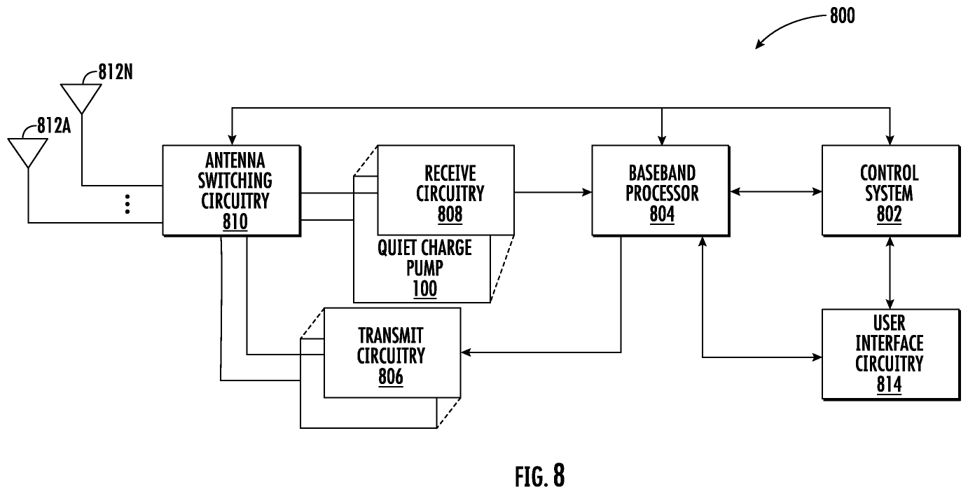

The output terminal 106 provides the output voltage Vddo and the output current Iddo generated by the quiet charge pump 100. The output voltage Vddo can be positive or negative depending on the specific design and application of the quiet charge pump 100. The output voltage Vddo can be used to power other devices, such as a user element shown in FIG. 8, or can be used to generate a clock signal.

The supply voltage filter 108 is coupled across the supply voltage rail 102 and the ground rail 104, and in one aspect, comprises a resistor R1 connected in series with parallel capacitors C1 and C2. In this configuration, the supply voltage filter 108 serves as a filter that attenuates certain frequencies and noise that may be present from the supply voltage rail 102 and in input voltage Vdda.

The capacitor ladder circuit 110 is coupled to the supply voltage filter 108 and comprises a first stage 112 and second stage 114. As shown, in one aspect, the capacitor ladder circuit 110 may comprise capacitors C3, C4, C5, and C6 that are connected in parallel across the supply voltage rail 102 and the ground rail 104 in first and second stages 112, 114, respectively. For example, as shown, the ladder circuit 110 may comprise the first stage 112 of capacitors C3 and C4 and the second stage 114 of capacitors C5 and C6. The second stage 114 is controlled by the switch 116, which comprises a resistor R2, an inverter 11, and a transistor M5 to control the sequence of charging and discharging of the capacitors C5 and C6. By staging the capacitors C3, C4, C5, and C6 in the first stage 112 and the second stage 114, the capacitor ladder circuit 110 may charge to a higher voltage progressively and generate a stepped-up voltage selectively using the switch 116. As shown, the switch 116 comprises the transistor M5 and the inverter 11 configured together as a switch.

In floating current source 118, the transistors M1, M2, M3, and M4 may be either NMOS or PMOS transistors. In pre-filter 122, the diode-connected resistor R3 and diode D1 are coupled from gate to drain of the transistor M1, and a capacitor C7 is coupled from gate to source of transistor M1. In one aspect, in pre-filter 122, the diode-connected resistor R3 and capacitor C7 function as a low pass filter that filters the voltage VGS to the transistor M1. That is, by implementing diode-connected resistor R3 and capacitor C7 as in pre-filter 122 as a low pass filter with transistor M1, the VGS and transistor M1 respond slowly to average demand of the quiet charge pump 100. This has the effect, among other things, of reducing ripple and noise by the quite charge pump 100 at output 106, which may result in a quieter output voltage Vddo and output current Iddo.

In steady state, the output from transistor M1 integrates a saw tooth wave on capacitor C7 to replenish the transferred charge transferred at clock edges of a clock signal (CS), e.g., used by the controller 124 (as will be further described with reference to FIG. 1B). During high-frequency operations, such as high-performance operations or load transients, the quiet charge pump 100 can be operated at higher frequency and voltage to reduce the output impedance and minimize the voltage drop using transistor M4 as a switch across the drain-to-source voltage (VDS) of transistor M1 and inverters 12 and 13 in the level shifter 120 for fast start-up. Transistors M2 and M3 may be connected as a switch across the resistor R3 to assist in initializing the VGS of transistor M1 before reducing the clock frequency and input voltage of the quiet charge pump 100 for steady-state operation.

Because the VGS and drain-to-source current of the transistor M1 change slowly proportional to differences in the VDS integrated over time, the current in transistor M1 follows the equation for an inductor, so that transistor M1 with a resistor-capacitor (RC) filter forms a synthesized inductor, where: L=Rgd*Cgs/GM1. The term Rgd is the gate-to-drain resistance of the transistor M1. The term Cgs is the gate-to-source capacitance of the transistor, and the term GM1 is the transconductance of the transistor M1.

The average VDS and VGS drop across the transistor M1 thus behaves as if it were an active, synthesized inductor.

In the level shifter 120, the inverters 12 and 13 are configured together to serve as a level shifter 120 and to operate by converting the voltage level from the second stage 114, i.e., the voltage generated from capacitors C5 and C6. As shown, inverter 12 is coupled to the gates of M2 and M3 and produces an output signal to inverter 13. Inverter 13 then inverts this output signal from 12 and provides an up-level shift output, which is provided to the gate of transistor M4. Hence, by using inverters 12 and 13 as the level shifter 120, it is possible to shift the voltage from the second stage 114 of the capacitor ladder circuit 110 from one voltage range to another in to adequately drive transistor M4, as desired.

Accordingly, based on the circuitry of the floating current source 118, the quiet charge pump 100 can operate quietly at start-up and high frequencies at elevated voltage, and at fast clocking frequencies with reduced voltage using pre-charge of the VGS with pre-filter 122 to an on-voltage followed by a transition to a low steady clock frequency. The quiet charge pump 100 can thus be used in any system having a variable speed clock (such as a user element shown in FIG. 8).

FIG. 1B illustrates an exemplary controller 124 and how it interfaces with the exemplary circuit diagram of the quiet charge pump 100 shown in FIG. 1A according to the present disclosure. Common elements shown in FIGS. 1A and 1B are shown with common element numbers. Any previous discussion of such common elements above is also applicable to FIG. 1B for sake of brevity and clarity. The controller 124 and its components will now be further described.

The controller 124 controls the operation of the quiet charge pump 100 and comprises a control logic 126 and a Pi filter 128, for example, based on a requested voltage for the quiet charge pump 100 and a requested clock signal frequency. Control logic 126 comprises various components to provide a clock source for the variable clock signal, or an input to receive a variable clock signal and a charge pump. For example, control logic 126 may comprise switches, capacitors, and diodes for a charge pump to transfer electric charge from one capacitor to another to create a higher or lower voltage output. In one aspect, the control logic is configured to receive various input signals to control the operation of the quiet charge pump 100. For example, the control logic 126 may receive input signals for enable and speed selection. As an output, control logic 126, may provide a voltage signal, filtered, or directly to Vneg, timed control signals used by the quiet charge pump 100 during its operations, shorted VDS and or shorted gate-to-drain voltage (VGD), or signals to control full filter operation, such as by pre-filter 122, without shorts.

The control logic 126 determines the timing and sequencing of the charge and discharge cycles between the capacitors, such as capacitors C1 and C2, in the quiet charge pump 100. The control logic 126 is responsible for generating the clock signal that drives the quiet charge pump 100 based on an input clock selection or trigger that may trigger a change in the variable clock frequency. In this regard, the control logic 126 comprises various logic elements, such as an oscillator and timer, that receives various signals, such as a clock select signal, commanded voltage level signal, and commanded voltage level change signal, and provides various outputs, such as Vneg. In one aspect, the control logic 126 is configured to ensure that the capacitors C5 and C6 are charged and discharged in a controlled manner by providing a clock signal based control signal (CS) to inverter 11 so that the output voltage Vddo remains stable and predictable during various modes of operation, as will be explained further below. The control logic 126 may also include additional circuitry (not shown in FIG. 1B for sake of clarity), such as level shifters, additional oscillators, a counter, additional timers, inverters, and logic elements such as AND and OR gates, to ensure that the quiet charge pump 100 operates correctly with the supply voltage rail 102 and output voltage Vddo desired for the quiet charge pump 100.

As also shown, the controller 124 may comprise the Pi filter 128 having holding capacitors C8 and C9, and a plurality of diodes D2, D3, D4, and D5 with resistors R4, R5, R6, R7, R8, R9, and R10. Holding capacitors C8 and C9 maintain the charge with the control logic 126 between clock cycles and stabilize the voltage levels within the control logic 126. Resistors R4, R5, R6, R7, R8, R9, and R10 are provided to filter the output current and set the desired voltage provided from the controller 124 at Vneg. The diodes D2, D3, D4, and D5 serve as clamping diodes by limiting the amount of voltage that can be generated across any part of the controller 124. For example, if a voltage exceeds the threshold of any of diodes D2, D3, D4, or D5. These diodes may go into their breakdown region and limit the voltage, thus protecting capacitors C8 and C9, as set during their manufacture process.

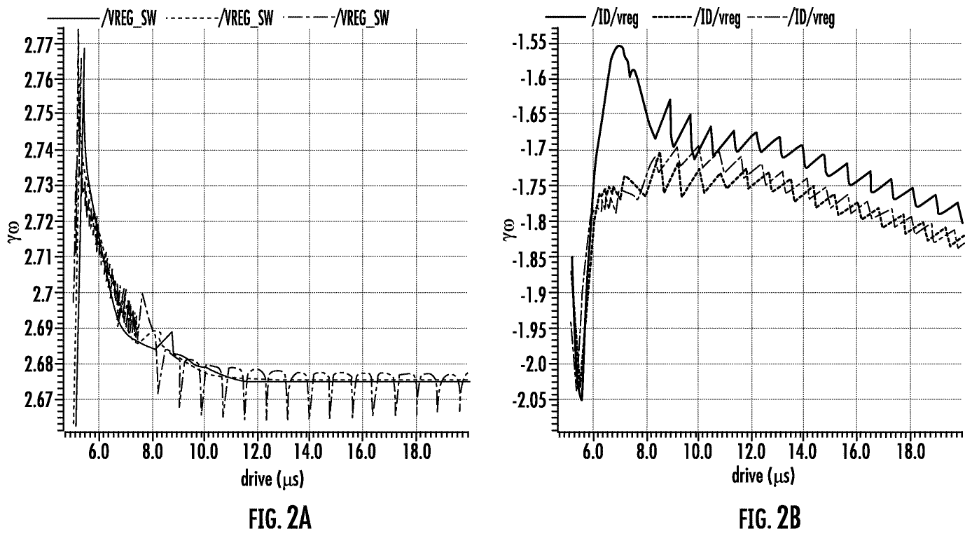

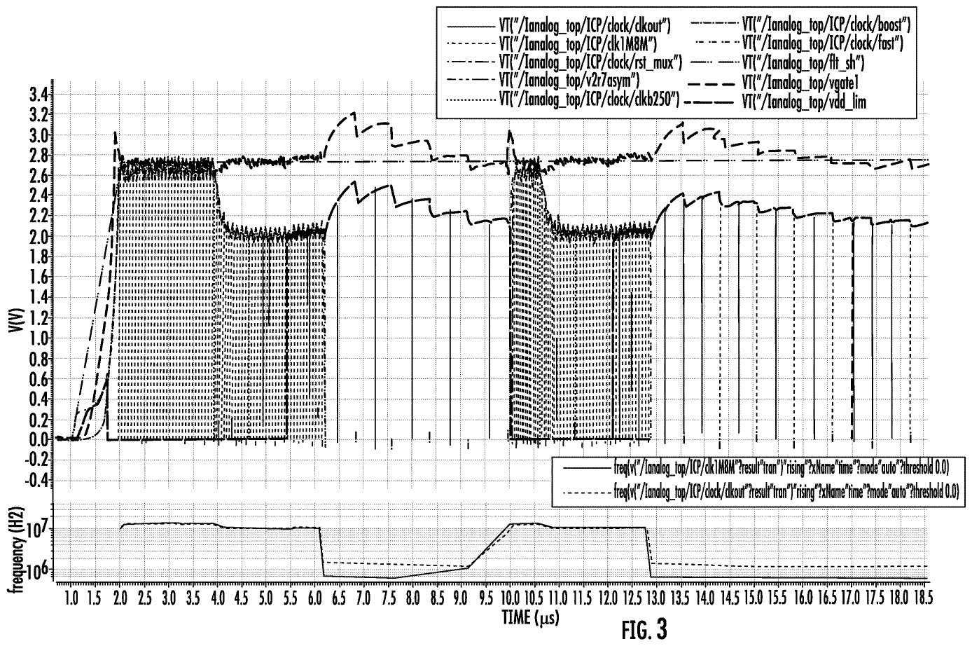

FIGS. 2A and 2B illustrate the performance of an embodiment comparison both prior to and according to the present disclosure, respectively. In particular, FIG. 2B shows a performance of the quiet charge pump 100 when operating under different sequenced clock frequencies. As noted, the quiet charge pump 100 may employ a clock signal that has a variable clock frequency provided from the control logic 126 making up the controller 124. For example, the clock signal may be relatively fast with a relatively high frequency at start-up. Accordingly, the floating current source 118 may operate based on an elevated voltage from capacitors C5 and C6, and the resistor R3 and capacitor C7 in the pre-filter are disengaged (e.g., shorted). The quiet charge pump 100 may then be operated by fast clocking frequency at a reduced voltage from capacitors C5 and C6 using a pre-charge of the VGS from capacitor C7 in the pre-filter 122. In steady-state or desired low-power operation, the quiet charge pump 100 may transition to a lower on-voltage followed by a transition to a low steady clock frequency. These transitions are shown in FIG. 3.

During operation of the quiet charge pump, almost no disturbance appears at the regulated voltage input to the charge pump. Making the quiet charge pump 100 quiet may have one or more benefits. For example, the quiet charge pump 100 may be quiet to reduce or prevent disturbing regulators (not shown). A quiet regulator connection with the quiet charge pump 100 may also be shared by a low-noise amplifier (LNA) (not shown) and by one or more quiet charge pumps without requiring the addition of an external RC filter to the LNA supply to further reduce the regulator output ripple particularly at the low charge pump frequency and its harmonics.

Ripple would otherwise corrupt the LNA output through the regulator supplying it.

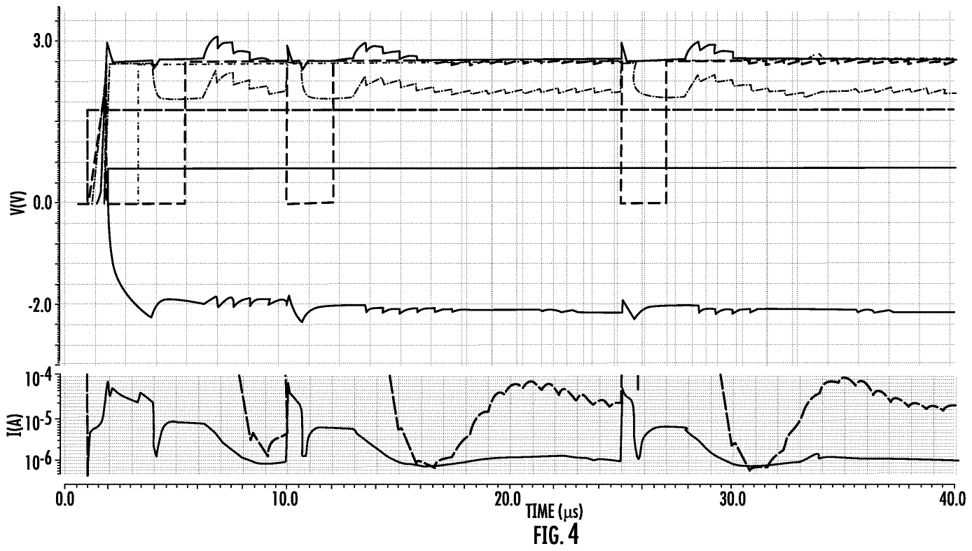

FIGS. 3 and 4 illustrate the performance of an embodiment according to the present disclosure. For example, FIG. 3 illustrates the gate and source voltages during the timed stages of charge pump operation, and the variable clock frequency monitored below. FIG. 4 represents the same operation as FIG. 3 but with attention to the Vneg output from the controller 124 and special attention below to the time varying current draw from the regulated input voltage, both a log scale showing two orders of magnitude change during mode sequencing and a zoomed in linear scale showing a reduced one hundred times regulator current ripple according to an aspect.

FIG. 4 illustrates the performance of an embodiment according to the present disclosure. In particular, the quiet charge pump 100 may be implemented with transistor M1 as a NMOS. The gate and source of the transistor M1 and the pre-filter 122 are shown along with the charge pump clock signal from the controller 124. The performance of the quiet charge pump 100 is illustrated when driven by divided or decoded control signals used for controlling first the supply VDS shorting the transistor M5 (as a PMOS) as a switch initially on for high voltage and then only later releasing the filter resistor parallel conductance to achieve the long-time constant desirable for VGS filtering during the low-frequency steady-state operation at lower voltage. During low-frequency operation, the gate and source of the current filtering NMOS M1 move together at constant VGS, for example, using the pre-filter 122.

With the pre-filter 122 engaged, the gate signal of the transistor M1 bootstraps above the supply at the clock frequency reduction because the oscillator on the same noisy supply draws reduced average current at low frequency. The excess current integrates on the bypass capacitor of the charge pump in control logic 126 to supply each clock edge. At each clock edge, some charge is transferred.

In FIG. 4, the lower scale shows clock frequency changing from about 13 MHz at start-up or transition to about 10 MHz intermediate then to about 0.6 MHz steady state. The floating current source 118 is only operational in the 10 MHz intermediate and the 0.6 MHz steady states. The 13 MHz clock noise had been filtered well enough by the RC networks already present, 20 times more effective at each stage compared with filtering the 0.6 MHz that just passes through. As shown, the bottom, zoomed-in linear scale is provided to illustrate a remaining current ripple, 0.3 μA down from about 100 times that ripple in the original diode-connected circuit for quiet charge pump 100. As shown, a diode-connected NMOS transistor M1 spikes to high currents to the regulated supply each time the charge pump makes a charge dump at its source, the noisy charge pump supply.

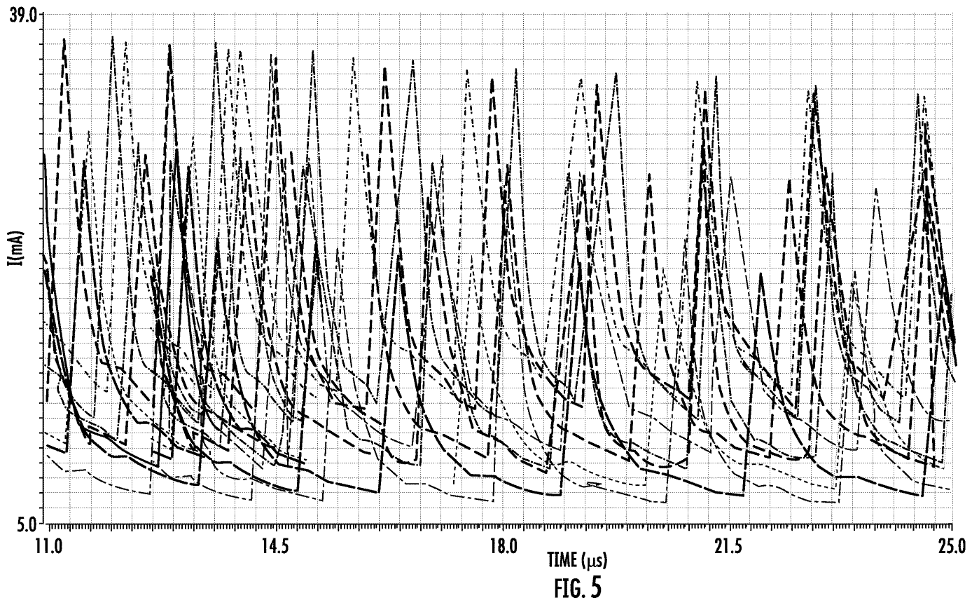

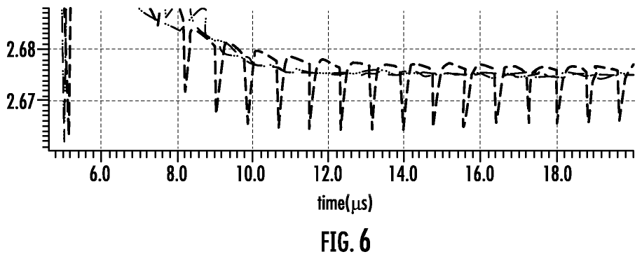

FIG. 5 illustrates the noisy current performance and current spikes of a conventional charge pump, which are resolved by an aspect of the present disclosure, and FIG. 6 illustrates the regulator performance of an embodiment prior to and according to the present disclosure. For example, as shown, the spikes peak at 20 μA to 30 μA depending on process corner and continue even when the charge pump is settled. The high-frequency content of the spike at each edge caused the voltage spikes at the output of the supply voltage filter 108 that are reduced or eliminated by the technique according to the present disclosure. Hence, even a ripple, 10 mV, for example, on the shared power supply of an LNA might pass in part to the output of the LNA and interfere, for example, with the fidelity of received radio frequency signal.

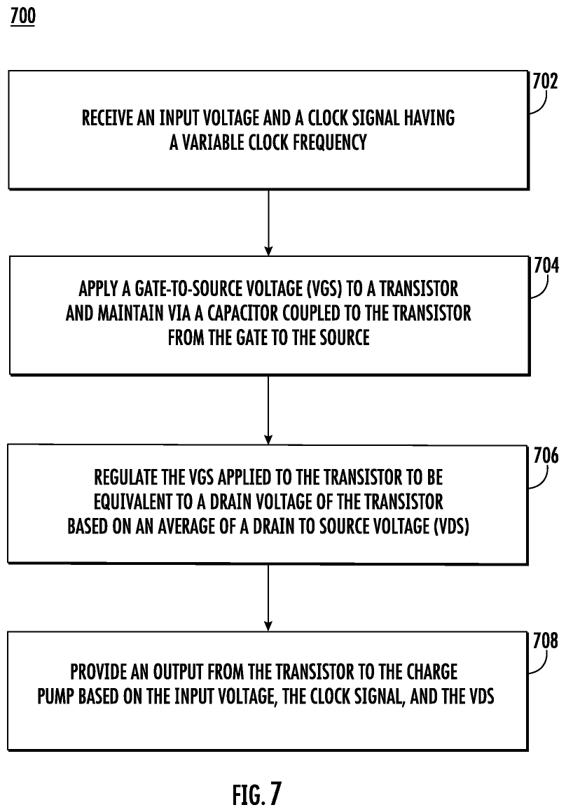

FIG. 7 illustrates an exemplary process flow 700 for operating the quiet charge pump 100. In a first step, an input voltage and a clock signal having a variable clock frequency is received (block 702 in FIG. 7). For example, the quiet charge pump 100 may receive an input voltage from supply voltage rail 102. In addition, the control logic 126 in controller 124 may provide a variable frequency clock signal.

In a next step, a VGS is applied to a transistor and is maintained via a capacitor coupled to the transistor from the gate to the source (block 704 in FIG. 7). In one aspect, the capacitor C7 and diode-connected resistor R3 in the pre-filter 122 serve as a low-pass filter on VGS of the transistor M1 in floating current source 118 and the current flowing to the charge pump input in the control logic 126 of controller 124. The capacitor C7 is coupled to the transistor M1 from the gate to source and at DC. The diode-connected resistor R3 at DC is also coupled from the gate to drain of transistor M1.

In a next step, the VGS applied to the transistor is regulated to be equivalent to a drain voltage of the transistor based on an average value of the VDS (block 706 in FIG. 7). In one aspect, at low clock frequencies, the pre-filter 122 causes the VGS and current of the transistor M1 in the floating current source 118 to respond advantageously slowly to average demand of the charge pump. This slower response input to the charge pump in control logic 126 reduces the noise created by the charge pump 100. At higher clock frequencies, the pre-filter is disengaged (e.g., shorted) by the controller 124 to allow the transistor M1 in the floating current source 118 to provide more responsive input to the charge pump in control logic 126. In an aspect, a switch across the drain-to-source voltage of the transistor M1 is provided to disengage or short the pre-filter, and thus, to enable the charge pump in control logic 126 to operate quietly, normally, at higher clock frequencies, where the Pi filter 128 in controller 124 is effective.

In a next step, an output 106 is provided from the transistor M1 based on the input voltage from the voltage supply rail 102 and the clock signal from the control logic 126 based on the VGS and current applied (block 708 in FIG. 7).

With reference to FIG. 8, the quiet charge pump 100 shown in FIGS. 1A and 1B and the concepts described above may be implemented in various types of user elements 800, such as mobile terminals, smart watches, tablets, computers, navigation devices, access points, and like wireless communication devices that support wireless communications such as cellular, wireless local area network (WLAN), Bluetooth, and near-field communications. The user elements 800 will generally include a control system 802, a baseband processor 804, transmit circuitry 806, receive circuitry 808 that includes the quiet charge pump 100, antenna switching circuitry 810, multiple antennas 812A-812N, and user interface circuitry 814. In a non-limiting example, the control system 802 can be a field-programmable gate array (FPGA) or an application-specific integrated circuit (ASIC), as an example. In this regard, the control system 802 can include at least a microprocessor, an embedded memory circuit, and a communication bus interface. The receive circuitry 808 receives radio frequency signals via the antennas 812A-812N and through the antenna switching circuitry 810 from one or more basestations. A low-noise amplifier and a filter of the receive circuitry 808 cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converters.

The baseband processor 804 processes the digitized received signal to extract the information or data bits conveyed in the received signal. This processing typically comprises demodulation, decoding, and error correction operations, as will be discussed in greater detail below. The baseband processor 804 is generally implemented in one or more digital signal processors and ASICs.

For transmission, the baseband processor 804 receives digitized data, which may represent voice, data, or control information, from the control system 802, which it encodes for transmission. The encoded data is output to the transmit circuitry 806, where a digital-to-analog converter converts the digitally encoded data into an analog signal and a modulator modulates the analog signal onto a carrier signal that is at a desired transmit frequency or frequencies. A power amplifier will amplify the modulated carrier signal to a level appropriate for transmission and will deliver the modulated carrier signal to the antennas 812A-812N through the antenna switching circuitry 810. The multiple antennas 812A-812N and the replicated transmit and receive circuitries 806, 808 may provide spatial diversity. Modulation and processing details will be understood by those skilled in the art.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

1. A circuit configured as a quiet charge pump, the circuit comprising:
an input configured to receive a variable frequency clock signal;
a charge pump configured to provide an output voltage based on the variable frequency clock signal;
a Pi filter coupled to the charge pump and configured to filter the output of the charge pump above a first frequency of the variable frequency clock signal;
a current source coupled to the charge pump and configured to provide a current to the charge pump, wherein the current source comprises a transistor having a gate, a source, and a drain, and wherein the current source is configured to provide a current responsive to a demand of the charge pump based on a gate-to-source voltage (VGS) applied during each clock cycle of the clock signal; and
a pre-filter coupled to the current source and configured to maintain the VGS at a desired level when the variable frequency clock signal is below the first frequency, wherein the pre-filter comprises:
a capacitor coupled to the transistor from the gate to the source; and
a resistor coupled between the capacitor and the transistor from the gate to the drain.

2. The circuit of claim 1, wherein the transistor comprises a P-type metal-oxide semiconductor transistor.

3. The circuit of claim 1, wherein the transistor comprises a N-type metal-oxide semiconductor transistor.

4. The circuit of claim 1, wherein the pre-filter is configured as a low-pass filter.

5. The circuit of claim 4, wherein the pre-filter maintains the VGS to be equivalent to a drain voltage of the transistor based on an average of the drain-to-source voltage.

6. The circuit of claim 1, further comprising a first switch across the drain-to-source of the transistor that is turned on based on the variable frequency of the clock signal to selectively disengage the pre-filter.

7. The circuit of claim 1, wherein the pre-filter comprises a resistor that is a diode-connected resistor coupled to an input voltage.

8. The circuit of claim 7, wherein the pre-filter further comprises a second switch across the diode-connected resistor that is configured to selectively short the diode-connected resistor based on the variable frequency clock signal and the input voltage.

9. The circuit of claim 1, wherein the charge pump further comprises a controller configured to provide a requested voltage output.

10. The circuit of claim 9, wherein the controller is configured to provide a requested clock frequency.

11. A method of operating a charge pump based on a clock frequency comprising:
receiving an input voltage and a clock signal having a variable clock frequency;
maintaining a gate-to-source voltage (VGS) applied to a transistor via a capacitor coupled to the transistor from a gate to a source;
regulating the VGS applied to the transistor to be equivalent to a drain voltage of the transistor based on an average value of a drain-to-source voltage (VDS); and
providing an output from the transistor to the charge pump based on the input voltage, the clock signal, and the VDS applied to the transistor.

12. The method of claim 11, wherein receiving the input voltage comprises:
turning on a first switch; and
providing a first voltage at startup of the charge pump and transitioning to a second voltage that is lower than the first voltage.

13. The method of claim 11, wherein regulating the VGS comprises providing a current to the transistor via a diode-connected resistor that is connected to the input voltage.

14. The method of claim 13 further comprising:
prior to transitioning to a lower on-voltage, turning on a second switch across the diode-connected resistor that is configured to selectively short the diode-connected resistor based on a variable clock signal and the input voltage.

15. The method of claim 14, wherein receiving the input voltage comprises:
providing a first voltage at startup of the charge pump and a first clock frequency;
transitioning to a second voltage after startup, wherein the second voltage is lower than the first voltage and the clock frequency remains at the first clock frequency; and
transitioning to a second clock frequency that is lower than the first clock frequency.

16. A wireless communication device comprising:
a base band processor configured to process a digitized version of a radio frequency (RF) signal to extract data bits conveyed in the received RF signal; and
receive circuitry configured to receive the RF signal from at least one antenna, wherein the receive circuitry comprises the quiet charge pump of claim 1.

17. The wireless communication device of claim 16, wherein the quiet charge pump comprises:
an input configured to receive a variable frequency clock signal;
a charge pump configured to provide an output voltage based on the variable frequency clock signal;
a Pi filter coupled to the charge pump and configured to filter the output voltage of the charge pump above a first frequency of the variable frequency clock signal;
a current source coupled to the charge pump and configured to provide a current to the charge pump, wherein the current source comprises a transistor having a gate, a source, and a drain, and wherein the current source is configured to provide a current responsive to a demand of the charge pump based on a gate-to-source voltage (VGS) applied during each clock cycle of the variable frequency clock signal; and
a pre-filter coupled to the current source and configured to maintain the VGS at a desired level when the variable frequency clock signal is below the first frequency, wherein the pre-filter comprises:
a capacitor coupled to the transistor from the gate to the source; and
a resistor coupled between the capacitor and the transistor from the gate to the drain.

18. The wireless communication device of claim 17, wherein the transistor comprises a P-type metal-oxide semiconductor transistor.

19. The wireless communication device of claim 17, wherein the transistor comprises a N-type metal-oxide semiconductor transistor.

20. The wireless communication device of claim 17, wherein the pre-filter is configured as a low-pass filter.

21. The wireless communication device of claim 20, wherein the pre-filter maintains the VGS to be equivalent to a drain voltage of the transistor based on an average of the drain-to-source voltage.

22. The wireless communication device of claim 17, further comprising a first switch across the drain-to-source of the transistor that is turned on based on the variable frequency of the clock signal to selectively disengage the pre-filter.

23. The wireless communication device of claim 17, wherein the pre-filter comprises a resistor that is a diode-connected resistor coupled to an input voltage.

24. The wireless communication device of claim 23, wherein the pre-filter further comprises a second switch across the diode-connected resistor that is configured to selectively short the diode-connected resistor based on the variable frequency clock signal and the input voltage.

25. The wireless communication device of claim 17, wherein the charge pump further comprises a controller configured to provide a requested voltage output.

26. The wireless communication device of claim 25, wherein the controller is configured to provide a requested clock frequency.
